(19) United States
(12) Patent Application Publication
(10) Pub. No.: US 2025/0089756 A1
(43) Pub. Date: Mar. 20, 2025

(54) FLAVORED CORE-SHELL CAPSULES FILM-COATED WITH POLYVINYLIDENE CHLORIDE

(71) Applicant: V. Mane Fils, Le-Bar-Sur-Loup (FR)

(72) Inventor: Luc GAUDIN, Villeneuve-Loubet (FR)

(21) Appl. No.: 18/576,999

(22) PCT Filed: Jul. 8, 2022
(86) PCT No.: PCT/FR2022/051375

§ 371 Date: Jan. 5, 2024

(30) Foreign Application Priority Data
Jul. 9, 2021 (FR) 2107521

(51) Int. Cl. A24B 13/02; A24B 15/28; A24D 3/02; A24D 3/06; B01J 13/04; B01J 13/20; B01J 13/22

(52) U.S. Cl. CPC A24B 13/02; A24B 15/283; A24D 3/0216; A24D 3/061; B01J 13/046; B01J 13/206; B01J 13/22

(57) ABSTRACT

The invention relates to a seamless breakable capsule of the core-shell type,
the shell comprising a hydrocolloid,
the core comprising a flavoring and a lipophilic solvent,
   characterized in that said shell is coated with a film coating layer that gives it water resistance, said film coating layer comprising polyvinylidene chloride;
   an oral-use pouch containing said capsule,
   a consumable product containing said capsule,
   a tobacco heating device containing said consumable product,
   a method for manufacturing said capsule,
   the use of said capsule as an agent for immediate and sustained release of a flavoring, and a method for flavoring an oral-use pouch.

### TECHNICAL FIELD

This invention relates to a seamless breakable capsule of the core-shell type, the shell comprising at least one hydrocolloid, said shell being coated with at least one layer of polyvinylidene chloride film coating which gives it water resistance. The capsule is intended to be incorporated into a tobacco heating device or into a product in an oral pouch.

### PRIOR ART

Due to their physicochemical properties, aromatic compounds are often sensitive and unstable molecules which are difficult to use directly in flavoring. Encapsulation, which utilizes the film-forming, absorbent, and/or emulsifying properties of macromolecules to trap or coat sensitive compounds in a microcapsule, is an increasingly used technology that satisfies several expectations. Indeed, the main goal of encapsulation is to establish a barrier between a substance and its surrounding environment. In the present case, the encapsulation of food flavorings is a well-known process for protecting volatile flavoring substances from evaporation and for protecting said substances from the degradation that could be caused by oxygen in the air, heat, humidity, or contact with other compounds. There are two main types of capsule structures: matrix capsules in which the flavorings are dispersed within a support material, and core-shell capsules in which the flavorings are confined within a shell (or membrane). In recent years, numerous applications for flavored capsules have been developed, particularly in smoking devices such as cigarettes and cigars, in tobacco heating devices, or in oral-use pouches (also called snus). We can cite patent application WO 07-010407 for example, which describes a smoking device in the form of a cigarette that incorporates a flavored core-shell capsule into its filter. The described capsule has hardness and deformability properties conferred by the amount of hydrocolloid added.

Patent applications WO2011042206 and WO2007037962 describe oral-use pouches comprising capsules and/or microcapsules having a conventional matrix and/or core-shell structure.

Patent application WO2011054516 describes an oral-use pouch comprising capsules covered with two different coatings, the first based on a methacrylic acid polymer and the second based on paraffin wax.

Patent applications WO2017198876, WO2017198874, and WO2020089120 describe tobacco heating devices comprising at least one core-shell capsule enclosing at least one flavoring. The capsules described in these documents have specific characteristics concerning the compounds used in the core of said capsules in order to improve the quality of the aerosol formed.

However, despite their advantages, the main disadvantage of all these core-shell capsules of the prior art, in which the shell is formed from biopolymer compounds, is that these capsules are not resistant to water, in particular when these capsules are completely immersed in water. They are not waterproof, which prevents the capsules of the prior art from withstanding the very high humidity found in tobacco heating devices, or even in oral pouch products. Therefore, the applications for flavored capsules as listed above do not satisfy consumers. A conventional way of preventing capsules from deteriorating due to humidity is to add a film coating layer using a moisture barrier agent such as waxes, in particular carnauba wax, candelilla wax, or beeswax, shellac (in alcoholic or aqueous solution), ethylcellulose, hydroxypropyl methylcellulose, hydroxypropyl cellulose, or polyvinyl alcohol. However, as their name indicates, these agents are moisture barriers or are referred to as moisture resistant, meaning they allow the capsule to resist a certain humidity for a certain time. But after a while, the capsule inevitably disintegrates.

Surprisingly, the Applicant has discovered that adding a layer of film coating based on polyvinylidene chloride over the shell of the capsule, allowed said capsule to resist water, and therefore to be waterproof. The capsules according to the present invention are able to withstand an immersion test at 60° C. for 6 minutes (condition found in tobacco heating devices) or to withstand a dissolution test carried out according to USP, DAB, IP, and EUR Pharmacopoeias, for 20 minutes at 37° C. In both cases, the polyvinylidene chloride-coated capsules do not disintegrate and retain their burst resistance properties, as well as the ability to emit an audible pop when ruptured.

### SUMMARY

This disclosure improves the situation.

Thus, this invention relates to a seamless breakable capsule comprising a shell enclosing a lipophilic flavoring core, said capsule being adapted for incorporation into a consumable product intended to be used in a tobacco heating device or in an oral-use pouch.

More precisely, a first object of the invention relates to a seamless breakable capsule of the core-shell type,
the shell comprising a hydrocolloid,
the core comprising a flavoring and a lipophilic solvent, characterized in that said shell is coated with a film coating layer which gives it water resistance, said film coating layer comprising polyvinylidene chloride.

A second object of the invention relates to an oral-use pouch for immediate and lasting release of a flavoring, characterized in that it comprises one or more capsules containing said flavoring according to the invention, said capsules being placed inside the pouch.

A third object of the application relates to a consumable product comprising a filter and tobacco, in particular intended to be used in a tobacco heating device, characterized in that said filter comprises one or more capsules according to the invention.

A fourth object of the invention relates to a tobacco heating device, characterized in that it comprises a consumable product according to the invention.

A fifth object of the invention relates to a method for manufacturing a seamless breakable capsule comprising a shell and a core, comprising the steps of:
(A) co-extrusion of a hydrophilic external liquid phase and a lipophilic internal liquid phase, the external liquid phase comprising from 4 to 95% by weight of a hydrocolloid relative to the total dry weight of the shell, the internal liquid phase comprising 5 to 70% by weight of flavoring agents relative to the total weight of the core;
(B) solidification and/or gelation of the surface of the capsule obtained in step (A), by immersion in a fluid that is at a temperature of between 1° C. and 25° C.; (C) drying of the capsule obtained in step (B);
(D) film coating of the capsule obtained in step (C) by an air spray coating process using a film coating solution comprising polyvinylidene chloride and water;
(E) retrieval of the capsule obtained in step (D).

A sixth object of the invention relates to the use of a capsule according to the invention, as an agent for immediate and lasting release of a flavoring, said capsule being placed in an oral-use pouch or in a consumable product comprising a filter and tobacco, in particular intended for use in a tobacco heating device.

A seventh object of the invention relates to a method for flavoring a product contained in an oral-use pouch according to the invention by a consumer, comprising the following steps:
the consumer places said product contained in an oral-use pouch between his or her gum and cheek or upper lip, in particular for 5 to 60 minutes;
at any time during consumption, the consumer bursts the capsule(s) comprised in the oral-use pouch between his or her teeth in order to release the flavoring contained in the capsule into his or her mouth.

### BRIEF DESCRIPTION OF DRAWINGS

Other features, details, and advantages will become apparent upon reading the detailed description below, and upon analyzing the attached drawings, in which:

FIG. 1 describes different compositions of core-shell capsules according to the invention, before film coating.

FIG. 2 describes different PVDC/TEC film coating solutions as well as the different dry deposits applied to the capsules according to the invention.

FIG. 3 describes the results for hardness, deformation, and audible pops of the capsules before and after the immersion test and dissolution test.

FIG. 4 describes different compositions of core-shell capsules according to the invention, before film coating.

FIG. 5 describes different formulations of PVDC/TEC film coating solutions as well as the different dry deposits applied to the capsules according to the invention.

FIG. 6 describes the results for hardness, deformation, and audible pops of the capsules before and after the immersion test and dissolution test.

FIG. 7 describes the results of the dissolution test for the capsules, carried out in Example 3.

FIG. 8 describes the results of the immersion test for the capsules, carried out in Example 3.

FIG. 9 describes the influence of capsule size on the film coating thickness.

FIG. 10 describes the influence of capsule size on the film coating thickness.

FIG. 11 describes the influence of capsule size on the film coating thickness.

FIG. 12 shows a photograph taken by scanning electron microscope, of a section of the capsule according to Example 1 in which the film coating layer has been separated from the shell.

FIG. 13 shows a photograph taken by scanning electron microscope, of a section of the capsule according to Example 1 in which the layer of film has not been separated from the shell.

### DESCRIPTION OF EMBODIMENTS

According to the invention, the capsule is a seamless breakable capsule and of the core-shell type,
the shell comprising a hydrocolloid,
the core comprising a flavoring and a lipophilic solvent, characterized in that said shell is coated with a film coating layer giving it water resistance, said film coating layer comprising polyvinylidene chloride.

In the invention, the term “capsule” designates a system of membrane encapsulation of a composition, said capsule having a core-shell structure, the encapsulated composition composing the “core” which is enclosed in a shell (or envelope) made of a coating material.

The capsule according to the invention differs from a matrix system where the composition is dispersed in a continuous matrix of a material and which is generally referred to by the term “microsphere”.

The fact that the capsule is seamless makes it possible to avoid the presence of a breaking point located at the seal between the two half-shells forming the capsule, as in the case of what are referred to as “softgel” capsules. Thus, the seamless capsule has the advantage of avoiding leaks related to seam ruptures.

The term “breakable capsule” refers to a capsule as defined above, in which the shell can be broken by means of pressure applied to the outside surface of the capsule when it is gripped between the fingers or teeth.

The capsules according to the invention have the advantage of being water-resistant or even waterproof. The term used here is water resistance, and not humidity resistance, the distinction between these two properties being significant. Indeed, traditional capsules coated using agents such as ethylcellulose, beeswax, or other such materials, are humidity-resistant, meaning that these capsules of the prior art resist a certain ambient level of humidity for a certain amount of time. However, after a defined time, these prior art capsules end up disintegrating. Under no circumstances can these capsules be immersed in hot water (at 37° C. or 60° C. for 20 minutes or 6 minutes respectively) and retain their shape and their burst-resistance properties.

Polyvinylidene chloride, also called PVDC, is a vinyl polymer. It is made from the monomer vinylidene chloride by vinyl free-radical polymerization. Polyvinylidene chloride copolymers are characterized by good chemical resistance and high impermeability to water vapor, gases, oils, and greases. For these reasons, PVDC is conventionally used in stretch film to protect foodstuffs. However, to the knowledge of the Applicant, to date it has never been used as a film coating agent, particularly in the specific case of encapsulation. PVDC used as a film coating agent allows the capsule according to the invention to have water-resistant properties when it is subjected to particular conditions.

The capsule according to the invention has a burst resistance (also called hardness or burst strength) of between 0.5 and 20 kgf (one kilogram-force corresponds to 9.81 Newton).

Burst resistance is measured by the crushing force required to break the capsule. More preferably, the capsule has a burst resistance between 1 and 8 kgf, and even more preferably between 1 and 4 kgf. The burst resistance of the capsules is measured by a TA.XT+texture analyzer on 20 capsules with a P0.5 piston at a speed of 0.50 mm/s.

When the capsule is crushed, it undergoes a deformation phenomenon. For the capsule to burst while generating an audible pop, the capsule must deform up to a certain limit, a limit beyond which the capsule does not burst (it collapses on itself). For this purpose, the capsule according to the invention must have a deformation percentage of less than 66%. This percentage corresponds to the ratio of the final diameter of the capsule when pressed to the breaking limit, to the initial diameter of the capsule, multiplied by 100.

In particular, the capsule according to the invention retains its burst resistance after being subjected to an immersion test in demineralized water at 60° C. while stirring at 500 rpm, for 6 minutes. “Retains its burst resistance” is understood to mean the fact that the burst resistance of the capsule does not vary by more than ±15% compared to its value before the immersion test.

Consequently, the capsules according to the invention allow having a very wide field of application, once water-resistance properties are required.

In addition, the capsule according to the invention retains its burst resistance after having been subjected to a dissolution test in water at 37° C. for 20 minutes. “Retains its burst resistance” is understood here to mean the fact that the burst resistance of the capsule does not vary by more than ±15% compared to its value before the dissolution test. Indeed, surprisingly, the Applicant has also discovered that the capsule according to the invention, when subjected to a dissolution test according to the USP, DAB, IP, and EUR pharmacopoeias, retains its qualities of burst resistance. In fact, the capsule subjected to said test for 20 minutes at 37° C. does not dissolve, retains its spherical shape, and retains its burst resistance as well as its ability to emit an audible pop when burst.

In order to obtain these particular burst resistance values under such conditions (immersion test in water at 60° C. for 6 minutes and dissolution test in water at 37° C. for 20 minutes), the capsules are therefore coated with a layer comprising polyvinylidene chloride. Preferably, the amount of polyvinylidene chloride is 50% to 100% by weight relative to the total dry weight of the film coating layer, in particular between 60% to 99%, in particular between 70% and 98%, more particularly between 80% and 97%, even more particularly between 90% and 96%. Polyvinylidene chloride is applied by a process of film coating by air spraying (also called “pneumatic spraying”) the capsules with a solution comprising polyvinylidene chloride diluted in water as solvent.

In a first embodiment, polyvinylidene chloride is used alone.

In a second embodiment, polyvinylidene chloride is used in a mixture with at least one plasticizer in order to compensate for the fact that PVDC can, depending on the conditions, become brittle. The plasticizers can be chosen among triethyl citrate (TEC), sugar alcohols such as glycerol, sorbitol, and maltitol, polyvinyl alcohol, mono-, di-, and oligosaccharides, triacetin, polyethylene glycol, or a mixture thereof. Advantageously, triethyl citrate is used as a plasticizer mixed with polyvinylidene chloride.

The plasticizer can be used at an amount of 0 to 20% by weight relative to the total dry weight of the film coating layer.

Advantageously, the thickness of the film coating layer is between 1 and 200 μm, preferably between 3 and 100 μm, and even more preferably between 3 and 50 μm.

One advantage of the capsule according to the invention is that it emits an audible pop when it is broken. This allows the consumer to be “informed” of the actual bursting of the capsule, when desired.

The shell of the capsule according to the invention advantageously comprises a hydrocolloid. Preferably, the hydrocolloid according to the invention is a biosourced polymer. Biosourced polymer is understood to mean a synthetic polymer that is partially (generally >20%) or totally obtained from derivatives from biomass. The biosourced nature of a polymer can be determined in particular from its C14 content, according to the ASTM D6866 standard.

The hydrocolloid of the capsule shell is chosen from gellan gum, gelatin (of animal origin or biotechnological origin), collagen, alginates, carrageenans, agar-agar, chitosan and its derivatives, pectins, gum arabic, gum ghatti, pullulan gum, mannan gum, vegetable proteins, or a mixture thereof. The amount of said hydrocolloid(s) present in the shell is from 4 to 95% by weight, preferably from 4% to 75% by weight, and even more preferably from 20% to 50% by weight relative to the total dry weight of the shell. In a preferred embodiment, the selected hydrocolloid is gellan gum used alone or in combination with gelatin. In another preferred embodiment, the hydrocolloid is chosen from the carrageenans.

Bulking agents may also be included in the shell's composition; bulking agent is understood to mean any suitable material capable of increasing the percentage of dry matter in the external liquid phase and therefore after co-extrusion into the shell of the capsule obtained. Increasing the amount of dry matter in the capsule's shell has the result of solidifying said shell and making it physically more resistant. Preferably, the bulking agent is chosen from the group comprising starch derivatives such as dextrin, maltodextrin, cyclodextrin (alpha, beta, or gamma), and hydroxypropyl starch derivatives, or cellulose derivatives such as hydroxypropyl methylcellulose (HPMC), hydroxypropyl cellulose (HPC), methylcellulose (MC), carboxymethyl cellulose (CMC), or polyvinyl alcohol, polyols, or mixtures thereof. Dextrin is the preferred bulking agent. The amount of bulking agent in the shell is a maximum of 98.5%, preferably 25 to 95%, more preferably 40 to 80%, and even more preferably 50 to 60% by weight relative to the total dry weight. of the shell.

The shell may advantageously comprise a coloring agent which can make the capsule comprising the flavoring composition more attractive. The coloring agent is preferably chosen from food-sourced dyes and pigments. The coloring may be within the body of the shell or applied by an additional coating process.

According to one embodiment, the dry weight of the shell is between 5 and 70%, preferably between 8 and 50%, more preferably between 8 and 20% by weight relative to the total dry weight of the capsule.

Preferably, the capsule has a diameter of between 1 and 6 mm. More preferably, the capsule has a diameter of between 2.5 and 5 mm.

Advantageously, the thickness of the shell of the capsule (without the film coating) is between 10 μm and 300 μm, preferably between 20 μm and 200 μm, and even more preferably between 30 μm and 150 μm.

There is a link between the thickness of the film coat layer, the diameter of the capsule, and the burst resistance of the film-coated capsule. Indeed, the Applicant has established that a particular ratio between the thickness of the film coating layer and the diameter of the capsule makes it possible to ensure that the film-coated capsule will have the required burst resistance:

$$Ratio ( R ) = ( thickness of the film coat layer \times 2 ) / diameter of the capsule .$$

Advantageously, the above ratio is greater than or equal to 0.18, advantageously greater than or equal to 0.2, more advantageously greater than or equal to 0.3, and even more preferably greater than or equal to 0.4.

The core of the capsule comprises one or more lipophilic solvents conventionally used in the food industry.

In a preferred embodiment, these lipophilic solvents may be triglycerides, in particular medium-chain triglycerides (MCT), and in particular caprylic and capric acid triglycerides, or mixtures of triglycerides such as vegetable oil, olive oil, sunflower oil, corn oil, peanut oil, grapeseed oil, wheat germ oil, mineral oils and silicone oils, or a mixture thereof.

The amount of lipophilic solvent in the core of a capsule according to the invention is about 0.01% to 90%, preferably 25% to 75%, of the total weight of the capsule.

The core may also comprise a flavoring comprising one or more flavoring molecules as conventionally used in the formulation of flavoring compositions. Such flavoring substances are mentioned, for example, in “Common Fragrance and Flavor Materials”, Wiley-VCH, Weinheim, 2006.

One can cite in particular aromatic, terpene and/or sesquiterpene hydrocarbons, and more particularly essential oils, alcohols, aldehydes, phenols, carboxylic acids in their various forms, aromatic acetals and ethers, nitrogen heterocycles, ketones, sulfides, disulfides and mercaptans which can be aromatic or non-aromatic.

The core may also comprise one or more fillers as used in flavoring emulsions. Examples include dammar gum, wood resins of the ester gum type, sucrose acetate isobutyrate (SAIB), or brominated vegetable oils. The function of these fillers is to adjust the density of the liquid core.

The core may also comprise one or more sweeteners, which may be in the form of a solution or suspension in ethanol. Examples of suitable sweeteners may be, but are not limited to, aspartame, saccharin, NHDC, sucralose, acesulfame, neotame, stevia and its derivatives, etc. The core may also comprise one or more “sensate” flavoring agents, which provide either a cooling effect or a warming effect in the mouth. Suitable cooling agents may be, but are not limited to, menthyl succinate and its derivatives, in particular Physcool®. A suitable warming agent may be, but is not limited to, vanillyl ethyl ether, or gold root.

Examples of suitable complex flavorings are vanilla, coffee, chocolate, cinnamon, and mint.

When the core of the capsule comprises several flavorings, the total amount of flavoring mixture is between 5% and 60% by weight relative to the total weight of the core of the capsule.

The second object of the invention relates to an oral-use pouch for immediate and lasting release of a flavoring, characterized in that it comprises one or more capsules as defined above containing said flavoring, said capsules being arranged inside the oral-use pouch. One of the applications of the capsules according to the invention is a use for flavoring oral pouches (also called snus), said pouches being porous and containing or not containing tobacco. The main advantage of using capsules in these snus products is that they provide flavoring by releasing the flavoring in an immediate and lasting manner, in the form of an “explosion”. Another advantage lies in allowing the consumer to choose the exact moment to burst the flavored capsule contained in the pouch, thus allowing the flavoring agents to be released. In fact, snus consumers are used to keeping said pouch in their mouth for up to an hour. It is therefore essential that the consumer be able to burst the capsule of the invention by experiencing both the sound of an audible pop, as well as the sensation of said capsule bursting between the teeth. As a result, the capsule must withstand remaining in the warm and humid environment formed by saliva (37° C. at a pH between 6.8 and 7.5) for a long period of time (one hour on the average), while maintaining sufficient hardness and deformability properties.

In a first embodiment, the pouch according to the invention comprises tobacco in the form of leaves or in the form of ground tobacco. This type of product contained in an oral-use pouch corresponds to conventional snus, in the sense that it contains tobacco. The tobacco present in the pouches has a very high humidity level, hence the importance of the capsules' water resistance. Indeed, taking into account a tobacco humidity of nearly 40%, the humidity imparted by saliva when the pouch is placed in the mouth, as well as the temperature in the mouth, the overall humidity level can reach 95%.

In a second embodiment, the oral-use pouch according to the invention does not contain tobacco. In this embodiment, the tobacco is replaced by a mixture comprising cellulose acetate fibers, a high amount of humectants, and pH adjusters, with or without nicotine. This new type of product has been developed in recent years to circumvent regulations prohibiting snus containing tobacco. However, these products, which reproduce the effect of a conventional snus, have the same disadvantages as conventional snus with tobacco, in the sense that the humidity level is high because of the humectants present in the pouch. In addition, whether or not the pouches contain tobacco, they are packaged in small boxes where the humidity is extremely high, because it is necessary to ensure the quality of the product before consumption.

The pouch according to the invention comprises one or more capsules.

According to one embodiment, the pouch according to the invention further comprises plant fibers, and/or encapsulated or unencapsulated flavoring agents, and/or filling agents, and/or humectants, placed inside the bag.

Said oral-use pouch may also comprise other flavoring agents present in various forms, in particular encapsulated or unencapsulated.

A third object of the invention relates to a consumable product comprising a portion comprising a filter and another portion comprising tobacco, characterized in that the filter comprises one or more capsules according to the invention.

Faced with the decline in cigarette sales, the tobacco industry has developed new products known as “reduced harm” products. These “reduced harm” products include tobacco heating devices which allow electrically heating “mini-cigarettes” or tobacco in “capsules” to between 180° and 350° (compared to 600° to 900° for the flammable cigarette) in order to release an aerosol. These devices, which heat tobacco without burning it, diffuse nicotine without combustion and without smoke, simply by aerosolization.

One application of the capsules according to the invention is their use for flavoring the aerosol (or “smoke”) formed when they are used in tobacco heating devices. When a tobacco heating device is used, the aerosol formed has a high moisture content and can reach temperatures between 50° C. and 70° C. The fact that the capsule withstands an immersion test in water at 60° C. for 6 minutes (which corresponds to the consumption time of the device) while maintaining its burst resistance properties makes it an ideal candidate for this application.

The capsules according to the invention can be incorporated into a consumable product comprising a portion which comprises a filter (made of cellulose acetate as in conventional cigarettes), and another portion which comprises tobacco. The capsule according to the invention thus placed in the filter can be burst at any time by the consumer while retaining the required properties of hardness and deformability so that said consumer knows exactly when he or she bursts said capsule to release its flavoring contents into the filter.

The consumable product comprises one or more capsules according to the invention.

Advantageously, the consumable product according to the invention is single-use and is intended to be used as a tobacco refill in a tobacco heating device.

A fourth object of the invention relates to a tobacco heating device, characterized in that it comprises the consumable product according to the invention. A tobacco heating device, as its name suggests, heats the tobacco to a temperature between 3° and 300° C., unlike conventional cigarettes in which the tobacco is burned and reaches a temperature between 70° and 800° C. In this type of device, the heated tobacco causes the formation of an aerosol which can be flavored, in particular using a capsule according to the invention. The consumable product according to the invention is inserted into the device to be smoked. The consumer turns on said device, and the tobacco is then heated by said device. The consumer can then at any time crush the capsule of the invention, which is located in the filter of the consumable product, and thus can flavor the aerosol formed by heating the tobacco.

A fifth object of the invention relates to a method for manufacturing a seamless breakable capsule comprising a shell and a core, comprising the steps of:
(A) co-extrusion of a hydrophilic external liquid phase and a lipophilic internal liquid phase, the external liquid phase comprising from 4 to 95% by weight of a hydrocolloid relative to the total dry weight of the shell, the internal liquid phase comprising 5 to 70% by weight of flavoring agents relative to the total weight of the core;
(B) solidification and/or gelation of the surface of the capsule obtained in step (A), by immersion in a fluid that is at a temperature of between 1° C. and 25° C.; (C) drying of the capsule obtained in step (B);
(D) film coating of the capsule obtained in step (C) by an air spray coating process using a film coating solution comprising polyvinylidene chloride and water;
(E) retrieval of the capsule obtained in step (D).

The co-extrusion process is a synchronous extrusion of two liquids: the hydrophilic external liquid phase, and the lipophilic internal liquid phase. The co-extrusion process includes three main stages: droplet formation, shell solidification, and capsule collection. The capsules of the invention may be produced by any suitable co-extrusion process. Preferably, the capsules are produced by a device and a method as described in EP 513603.

According to one embodiment of the invention, after the co-extrusion step, the solidification step is carried out while keeping the capsules cold in order to ensure good gelation of the shell, for example by placing them in contact with a cold fluid. The cold fluid is preferably cold oil. Cold within the meaning of the invention is understood to mean a temperature between 1 and 25° C., preferably 2 and 10° C., more preferably between 4 and 6° C. The capsules can then be centrifuged to remove excess oil, possibly washed with an organic solvent—also to remove excess oil—and dried. According to one embodiment of the invention, after the co-extrusion step, and possibly the solidification step, the capsules are centrifuged.

According to another embodiment of the invention, the capsules are co-extruded, centrifuged, and possibly immersed in a solution or an emulsion containing an agent which allows hardening the shell of the capsules, or chelating agent.

The chelating agent may be ethanol or any other anhydrous organic solvent, maintained at a temperature between 0 and 25° C., more particularly between 1° and 20° C.

The chelating agent may also be a bath of calcium ions, for example calcium chloride, dicalcium phosphate, or calcium sulfate, having a pH between 5 and 8. The bath of calcium ions is preferably at a temperature of 0 to 25° C., preferably 10 to 20° C.

After the immersion step (B), the capsules are dried (step (C)), for example in a current of air at controlled temperature and humidity. The relative humidity of the drying air is 20% to 60%, preferably 30 to 50%; the temperature of the drying air is 15 to 60° C., preferably 35 to 50° C. If necessary, the surface oil can be removed using an adsorbent agent such as silica, or a starch added during drying: between 0.1 and 5%, preferably between 0.1 and 2%.

Step (D) is the crucial step of film coating the capsules, during which an outer layer of polyvinylidene chloride is applied to the capsules. “Film coating” is understood to mean a process allowing a thin layer of a film coating agent to be deposited on a support. In the present case, the film coating process is carried out by a process of air spraying a solution of a film coating agent (here polyvinylidene chloride) in order to convey the generated microdroplets onto a support (here the capsule). For these reasons, we clearly distinguish the film coating process from a coating process which allows covering a support with a thick layer, without the use of a carrier fluid (therefore without air) and by any process other than spraying.

The film coating step is carried out by an air spraying process with a solution comprising at least polyvinylidene chloride and water. In a first embodiment, polyvinylidene chloride is used in a solution at 8 to 50% by weight diluted in water.

Preferably, the film coating solution comprises polyvinylidene chloride, water, and at least one plasticizer chosen from triethyl citrate, polyhydric alcohols such as glycerol, sorbitol, and maltitol, polyvinyl alcohol, mono-, di-, and oligosaccharides, triacetin, and polyethylene glycol.

The capsules manufactured using the method of the invention are essentially or perfectly spherical and of uniform size.

A sixth object of the invention relates to the use of a capsule according to the invention, as an agent for the immediate and lasting release of a flavoring, said capsule being placed in an oral-use pouch or in a consumable product comprising a filter and tobacco, in particular intended for use in a tobacco heating device. In this embodiment, when the capsule is broken within an oral-use pouch or a consumable product, it emits an audible pop and bursts to release the flavoring it contains.

A seventh object of the invention relates to a method for flavoring a product contained in an oral-use pouch according to the invention by a consumer, comprising the following steps:
the consumer places said oral-use pouch between his or her gum and cheek or upper lip, in particular for 5 to 60 minutes;
the consumer bursts the capsule(s) comprised in the oral-use pouch between his or her teeth in order to release the flavoring contained in the capsule into his or her mouth.

The invention is illustrated below by the following examples, which should not be considered as limiting the scope of the invention, and are to be read with reference to the figures.

### EXAMPLES

### Example 1

### 1. Composition of the Capsule Before Film Coating (Table 1)

% are expressed by weight.

TABLE 1

| | Raw material | % |
|---|---|---|
| S | SODIUM CITRATE | 0.17% |
| S | GELLAN GUM | 1.53% |
| S | FISH GELATIN | 1.70% |
| S | BEEF GELATIN | 1.70% |
| S | SORBITOL | 0.85% |
| S | GLYCERIN | 0.85% |
| S | HP STARCH | 0.43% |
| S | DEXTRIN | 7.67% |
| S | TARTRAZINE DYE | 0.01% |
| S | SILICA | 1.50% |
| S | WATER | 1.50% |
| F | MCT | 70.12% |
| F | MENTHOL | 4.23% |
| F | FLAVORING COMPOSITION | 7.72% |
| | Total | 100.00% |

F = Ingredients contained in the capsule flavoring
S = Ingredients contained in the capsule shell

### Preparation of the Capsule Film:

the water, sodium citrate, glycerin, and sorbitol are weighed in a beaker, then the mixture is stirred and heated to 85° C.,
the gellan gum is weighed and incorporated into the beaker,
the gelatins, dextrin, starch, and coloring agents are weighed and incorporated into the beaker, and
the mixture is stirred until the ingredients dissolve, then left to degas.

### Co-Extrusion Procedure:

pump the above film solution at 85° C. into the concentric nozzle,
separately pump a flavored liquid base solution composed of menthol, mint essential oil, and aromatic molecules in MCT at room temperature to the concentric nozzle,
simultaneously extrude the two solutions through the coaxial nozzles in a MCT at low temperature (approx. 10° C.). Co-extrusion instantly causes the formation of two drops one inside the other, called the core and shell, at a ratio of approximately 90/10,
the solution of the outer shell gels around the flavoring core due to the drop in temperature,
collect the gelled wet capsules in cold MCT and allow to solidify at 4° C. for 1 hour,
remove the MCT by centrifugation,
mix then dry the capsules in a dryer using a flow of hot air (around 45° C.) and a drying aid (silica), and
collect and sift the dried capsules.

### 2. Preparation of Film Coating Solution (Table 2)

% are expressed by weight.

TABLE 2

| | |
|---|---|
| SUSPENSION of PVDC | 35.29% |
| TRIETHYL CITRATE | 2.00% |
| (TEC) | |
| WATER | 62.71% |
| | Total 100.00% |

### Procedure:

weigh the water in a beaker,
weigh the polymer (PVDC) and the plasticizer (TEC),
pour in the polymer solution and the plasticizer while stirring and leave for 15 min at room temperature,
control the stirring to avoid foam formation, and
keep stirring gently during the film coating process.

Table 3 below shows the characteristics of the film coating solution.

TABLE 3

| | | |
|---|---|---|
| FILM COATING | Dry matter (% by weight) | 20 |
| SOLUTION | viscosity (cP) | 1.88 |
| | pH at 20° C. | 2.1 |
| | density (g/cm3) | 1.094 |

### 3. Film Coating Process:

Introduce the capsules obtained at the end of the coextrusion, into the film coating turbine.
Weigh the film coating solution on a balance.
Install the desired spray nozzles, previously loaded and purged with film coating agent, inside the film coating turbine.
Rotate the turbine at the desired rotation speed.
Preheat the incoming air to 40° C. and at the desired flow rate.
Begin spraying the polymer solution when the temperature of the capsule to be coated has been reached (approximately 26° C.).
Stop spraying when the desired dry deposit percentage has been reached (i.e. when the desired weight of film coating solution to be applied has been reached).
Perform a stabilization step by cooling the temperature of the incoming air (approximately 20 min).
   4. Analyses of Capsules Before and After Film Coating, and after Immersion Test and Dissolution Test (Table 4)

The film-coated capsules are subjected to an immersion test in water at 60° C. for 6 minutes according to the following protocol:

### Preparation:

Preheat the water that will be used for the test.
Count out 200 capsules using the counting plate.
In order to eliminate any trace of residual oil or other impurity, immerse the capsules in 200 ml of demineralized water at room temperature while stirring (250 RPM), for 20 s. Collect the capsules using a sieve and dry them lightly on cotton wool.

### Immersion Test:

Start the water bath, set the temperature at 60° C. for an internal temperature in the beaker of 60° C. +/−1° C.
Weigh 200 g of demineralized water into the beaker.
Place the beaker in the water bath and insert the magnetic bar, begin stirring at 500 rpm.
Pour the capsules into the beaker.
Time for 6 min.
At the end of 6 minutes, note the color of the water and count the number of capsules that have burst or risen to the surface. Note also the possible presence of an odor (which would correspond to the flavoring).
Collect the capsules in a sieve, spread them on cotton wool to dry them.
Observe their appearance and perform the analyses.

The film-coated capsules are subjected to a dissolution test in water at 37° C. for 20 minutes according to the following protocol:
Heat the water tank of the water bath to 39° C.
Introduce water filtered by reverse osmosis into the test beaker.
Once the water has reached 37° C., measure the pH, which must be between 6.8 and 7.5.
Introduce 21 capsules into the well.
Set the timer to 20 minutes.

### Start the Procedure:

The well descends 55 mm at a rate of 30 strokes per minute.
The capsules remain completely immersed in water at 37° C.
After 20 minutes, remove the capsules, blot them lightly with cotton wool, and perform the analyses.
   Results of Capsule Analyses Before and After Film Coating, and after Immersion Test and Dissolution Test (Table 4).

TABLE 4

| | | |
|---|---|---|
| CAPSULE | Mean weight (mg) | 63.6 |
| BEFORE | Diameter (mm) | 5049 |
| FILM | Hardness (kgF) | 2.44 |
| COATING | Elongation at break (%) | 45 |
| | Sound at break (db) | 90 |
| FINAL FILM- | Mean weight (mg) | 65.3 |
| COATED | Diameter (mm) | 5070 |
| CAPSULE | Hardness (kgF) | 2.58 |
| | Elongation at break (%) | 48 |
| | Sound at break (db) | 84 |
| FINAL FILM-COATED | Hardness (kgF) | 2.35 |
| CAPSULE AFTER | Elongation at break (%) | 52 |
| IMMERSION TEST AT 60° C. | Sound at break (db) | 83 |
| FOR 6 MINUTES | | |
| FINAL FILM-COATED | Hardness (kgF) | 2.49 |
| CAPSULE AFTER | Elongation at break (%) | 31 |
| DISSOLUTION TEST IN | Sound at break (db) | 88 |
| WATER AT 37° C. FOR 20 | | |
| MINUTES | | |

Analyses of the capsules before and after film coating, and after immersion test and dissolution test (Table 4).

We can see from Example 1 that the film-coated capsule according to the invention retains both:
burst resistance (hardness) equivalent to what was measured before the immersion and dissolution tests;
the capacity to emit an audible pop (greater than 80 db) equivalent to what was measured before the immersion and dissolution tests.

### Example 2

Influence of “dry deposit”.

Dry deposit is a factor which reflects the thickness of the film coating layer. It is calculated by finding the ratio (Final Capsule Weight−Initial Capsule Weight)/Initial Capsule Weight.

In Example 2, capsules of equivalent diameter (3.5 mm approx.) were manufactured with variable dry deposits in order to evaluate the influence of the dry deposit on the properties of the capsules.

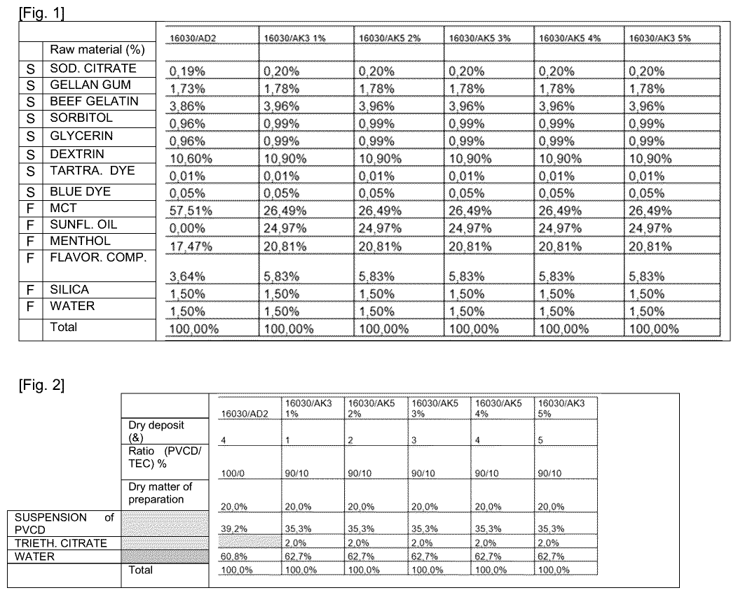

The table in FIG. 1 describes different compositions of core/shell capsules before film coating.

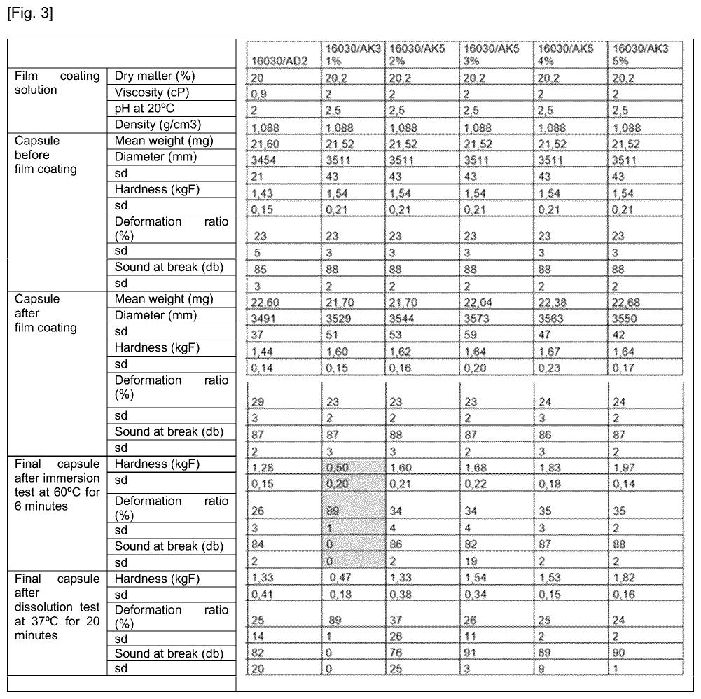

The table in FIG. 2 describes different PVDC/TEC film coating solutions as well as the different dry deposits applied to the capsules in the table in FIG. 1.

The table in FIG. 3 describes the results for hardness, deformation, and audible pop of the capsules before and after the immersion and dissolution tests.

It can be seen from these tests that capsules with a diameter of 3.5 mm having a dry deposit of less than 1% (reference capsules 16030/AK3 1%) do not hold up during the immersion test in water at 60° C. for 6 minutes, nor during the dissolution test in water at 37° C. for 20 min.

### Example 3

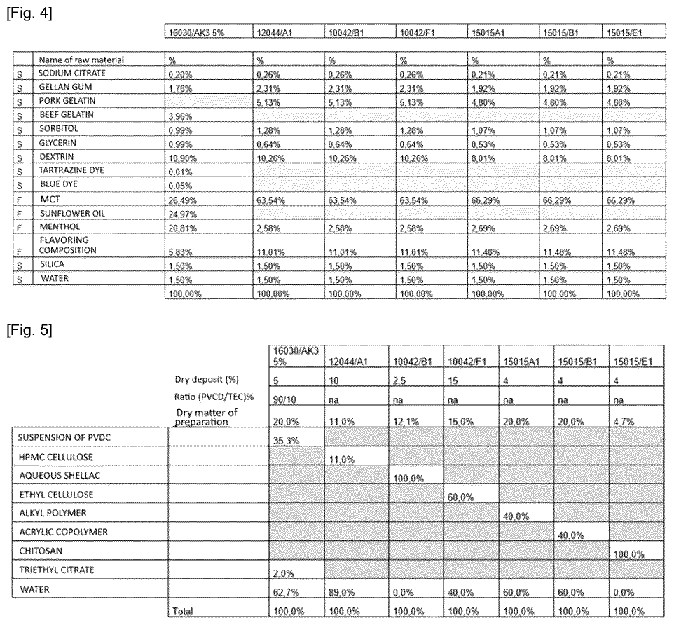

The capsules are manufactured according to Example 1. The table in FIG. 4 describes the different formulations of core-shell capsules.

In a second step, the capsules are film-coated according to example 1. The table in FIG. 5 describes different formulations of film coating solutions using different film coating agents and with different dry deposit values.

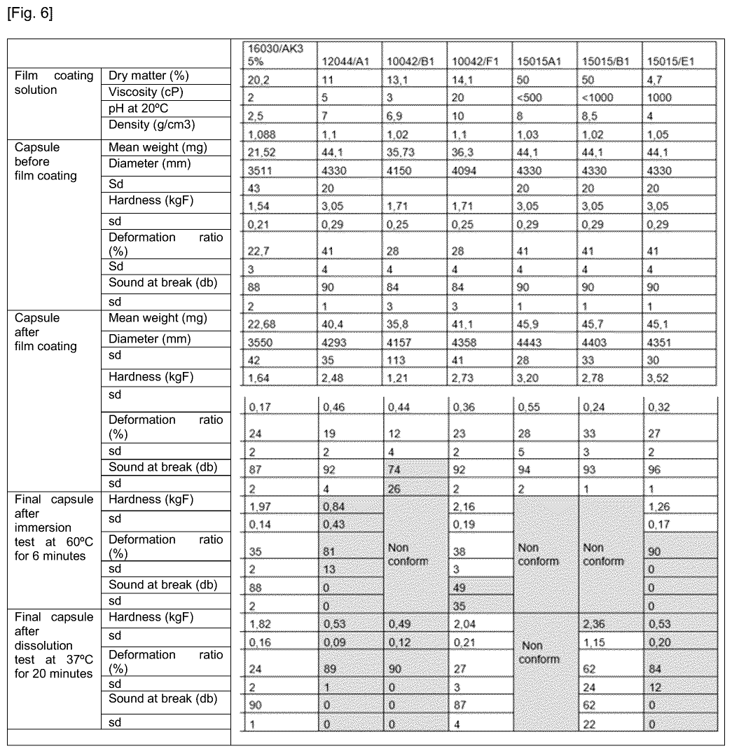

The film-coated capsules are subjected to an immersion test in water at 60° C. for 6 minutes and to a dissolution test in water at 37° C. for 20 minutes according to the protocols as described in Example 1. Analyses of the capsules before film coating, and after the immersion test and dissolution test, are carried out as described in Example 1. The results are summarized in Tables 5 and 6 below, as well as in FIG. 6.

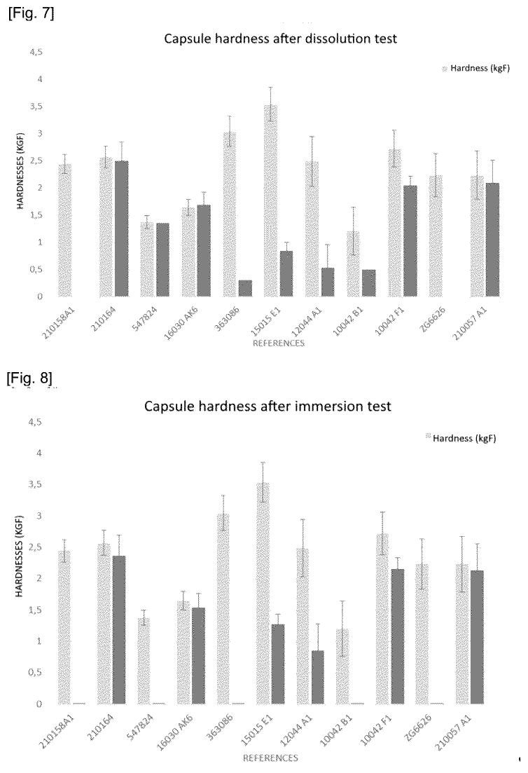

FIGS. 7 and 8 are graphical representations of the results described in Tables 5 and 6 and describe all the hardness results after the immersion and dissolution tests, according to the film coating agent used.

TABLE 5
Hardness and sound at break after immersion test.

| | | | | | | | | | Audible |
|---|---|---|---|---|---|---|---|---|---|
| | | Shell base | | | | Audible | Hardness | | pop after |
| Capsule | Size | Animal/Non- | Film | Hardness | | pop | after test | | test |
| reference | (mm) | Animal | coating | (kgF) | SD | (Yes/No) | (KgF) | SD | (Yes/No) |
| 210158A1 | 5 | G | None | 2.44 | 0.18 | Yes | 0.01 | 0 | No |
| 210164 | 5 | G | PVDC | 2.57 | 0.2 | Yes | 2.35 | 0.35 | Yes |
| 547824 | 3.5 | G | None | 1.37 | 0.12 | Yes | 0.01 | 0 | No |
| 16030 AK6 | 3.5 | G | PVDC | 1.64 | 0.15 | Yes | 1.53 | 0.23 | Yes |
| 363086 | 4.5 | G | None | 3.04 | 0.28 | Yes | 0.01 | 0 | No |
| 15015 E1 | 4.5 | G | Chitosan | 3.54 | 0.32 | Yes | 1.26 | 0.17 | No |
| 12044 A1 | 4.5 | G | HPMC | 2.48 | 0.46 | Yes | 0.84 | 0.43 | No |
| 10042 B1 | 4.5 | G | Shellac | 1.2 | 0.44 | Yes | 0.01 | 0 | No |
| 10042 F1 | 4.5 | G | EC | 2.72 | 0.34 | Yes | 2.15 | 0.18 | No |
| ZG6626 | 5 | V | None | 2.23 | 0.4 | Yes | 0.01 | 0 | No |
| 210057 A1 | 5 | V | PVDC | 2.23 | 0.45 | Yes | 2.12 | 0.43 | Yes |

G = gelatin
V = carrageenan or gellan gum

TABLE 6
Hardness and sound at break after dissolution test.

| | | | | | | | | | Audible |
|---|---|---|---|---|---|---|---|---|---|
| | | Shell base | | | | Audible | Hardness | | pop after |
| Capsule | Size | Animal/Non- | Film | Hardness | | pop | after test | | test |
| reference | (mm) | Animal | coating | (kgF) | SD | (Yes/No) | (KgF) | SD | (Yes/No) |
| 210158A1 | 5 | G | None | 2.44 | 0.18 | Yes | 0 | 0 | No |
| 210164 | 5 | G | PVDC | 2.57 | 0.2 | Yes | 2.49 | 0.43 | Yes |
| 547824 | 3.5 | G | None | 1.37 | 0.12 | Yes | 1.35 | 0.21 | Yes |
| 16030 AK6 | 3.5 | G | PVDC | 1.64 | 0.15 | Yes | 1.68 | 0.33 | Yes |
| 363086 | 4.5 | G | None | 3.04 | 0.28 | Yes | 0.30 | 0.20 | No |
| 15015 E1 | 4.5 | G | Chitosan | 3.54 | 0.32 | Yes | 0.83 | 0.44 | No |
| 12044 A1 | 4.5 | G | HPMC | 2.48 | 0.46 | Yes | 0.53 | 0.09 | No |
| 10042 B1 | 4.5 | G | Shellac | 1.2 | 0.44 | Yes | 0.49 | 0.12 | No |
| 10042 F1 | 4.5 | G | EC | 2.72 | 0.34 | Yes | 2.04 | 0.21 | Yes |
| ZG6626 | 5 | V | None | 2.23 | 0.4 | Yes | 0.00 | 0.00 | No |
| 210057 A1 | 5 | V | PVDC | 2.23 | 0.45 | Yes | 2.08 | 0.46 | Yes |

G = gelatin
V = carrageenan or gellan gum

Note that all the capsules coated with a polymer other than PVDC do not hold up during the immersion test in water at 60° C. for 6 minutes.

In the case of ethyl cellulose (EC), note that the capsules (reference 10042/F1) withstood the immersion test, however the sound emitted at capsule break is much lower than 80 db (49 db). This relative resistance is not due to the fact that ethyl cellulose provides this property, but is due to the fact that ethyl cellulose is used in large amounts (15% dry deposit, see Table in FIG. 5).

PVDC (here used in mixture with TEC) is the only film coating agent which allows the capsule to withstand the immersion and dissolution tests.

### Example 4

G=gelatin

Influence of capsule size on film thickness. Relationship between film coating thickness, dry deposit, and determination of the ratio (thickness of the film coating layer)×2/capsule diameter.

In Example 4, capsules of different diameters are film coated according to Example 1, with PVDC or ethyl cellulose.

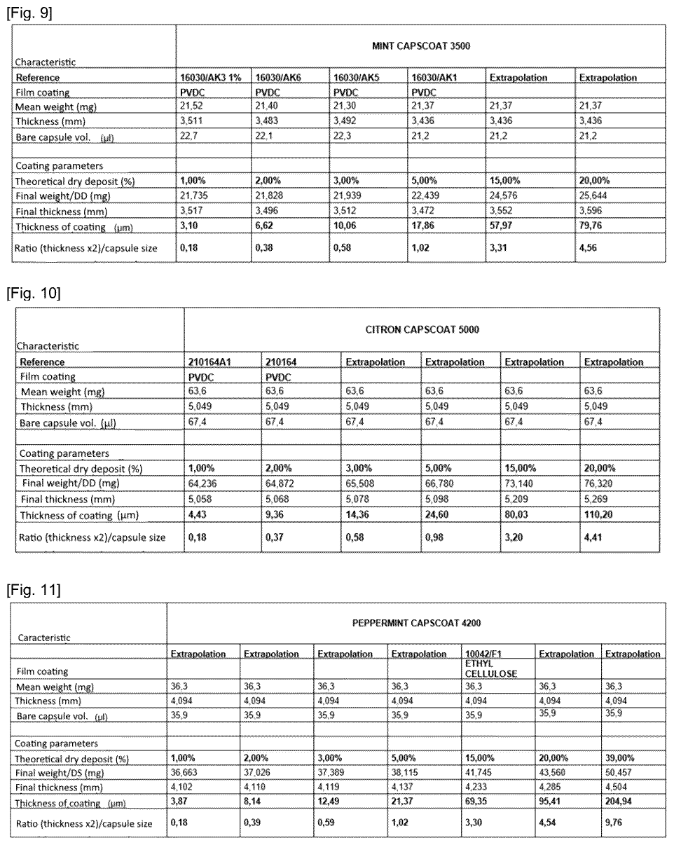

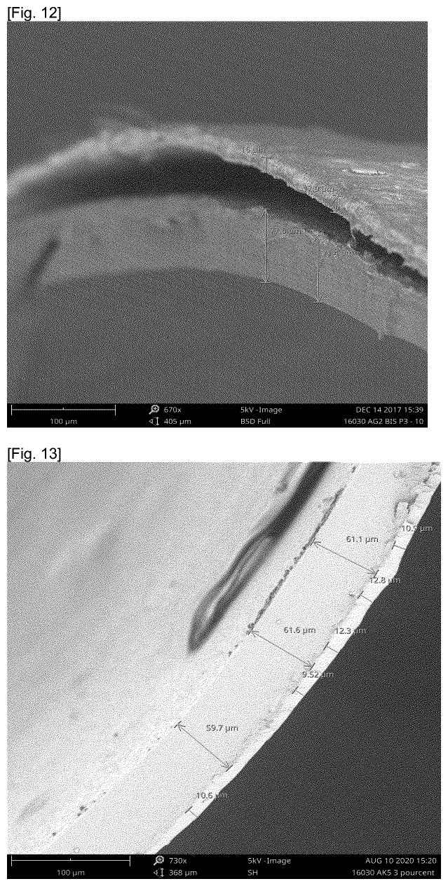

The tables in FIGS. 9 to 11 summarize the film coating characteristics.

At identical dry deposit values, the thickness of the film coating layer is different depending on the size of the capsule. As the dry deposit increases, the thickness of the film coating layer increases with the size of the capsule.

For example, a dry deposit of 3% for a capsule that is 3.5 mm in diameter does not have the same impact on the thickness of the film coating layer as a dry deposit of 3% on a capsule that is 5 mm in diameter. It is respectively 10.059 μm and 14.364 μm.

The ratio (thickness of the film coating layer)×2/diameter of the capsule remains identical regardless of the size of the capsule; in the context of the above example, R=0.575.

1. Seamless breakable capsule of the core-shell type,
the shell comprising a hydrocolloid,
the core comprising a flavoring and a lipophilic solvent,
characterized in that said shell is coated with a film coating layer which gives it water resistance, said film coating layer comprising polyvinylidene chloride.

2. Breakable capsule according to claim 1, wherein it retains its burst resistance after being subjected to an immersion test at 60° C. for 6 minutes.

3. Breakable capsule according to claim 1, wherein it has a burst resistance of between 0.5 and 20 kgf after having been subjected to a dissolution test in water at 37° C. for 20 minutes.

4. Breakable capsule according to claim 1, wherein the amount of polyvinylidene chloride is 50% to 100% by weight relative to the total dry weight of the film coating layer.

5. Breakable capsule according to claim 1, wherein the film coating layer further comprises a plasticizer.

6. Breakable capsule according to claim 5, wherein the plasticizer is chosen from triethyl citrate, polyhydric alcohols such as glycerol, sorbitol, and maltitol, polyvinyl alcohol, mono-, di-, and oligosaccharides, triacetin, polyethylene glycol, or a mixture thereof.

7. Breakable capsule according to claim 1, wherein the thickness of the film coating layer is between 1 and 200 μm.

8. Breakable capsule according to claim 1, wherein it emits an audible pop when it is broken.

9. Breakable capsule according to claim 1, wherein the shell comprises a hydrocolloid chosen from gellan gum, gelatin, collagen, alginates, carrageenans, agar-agar, chitosan and its derivatives, pectins, gum arabic, gum ghatti, pullulan gum, mannan gum, vegetable proteins, or a mixture thereof.

10. Breakable capsule according to claim 9, wherein the hydrocolloid is gellan gum used alone or in combination with gelatin.

11. Breakable capsule according to claim 9, wherein the hydrocolloid is chosen from the carrageenans.

12. Breakable capsule according to claim 1, wherein the capsule has a diameter of between 1 and 6 mm.

13. Breakable capsule according to claim 1, wherein the thickness of the shell of the capsule is between 10 μm and 300 μm.

14. Oral-use pouch for immediate and lasting release of a flavoring, characterized in that it comprises one or more capsules containing said flavoring according to claim 1, said capsules being placed inside the pouch.

15. Oral-use pouch according to claim 14, wherein it further comprises tobacco in the form of leaves or in the form of ground tobacco placed inside the pouch.

16. Oral-use pouch according to claim 14, wherein it does not comprise tobacco placed inside the pouch.

17. Oral-use pouch according to claim 1, further comprising plant fibers, and/or encapsulated or unencapsulated flavoring agents, and/or filling agents, and/or or humectants, placed inside the bag.

18. Consumable product comprising a portion comprising a filter and another portion comprising tobacco, characterized in that the filter comprises one or more capsules according to claim 1.

19. Consumable product according to claim 18, wherein it is single-use and is intended to be used as a tobacco refill in a tobacco heating device.

20. Tobacco heating device, characterized in that it comprises the consumable product according to claim 18.

21. Method for manufacturing a seamless breakable capsule comprising a shell and a core, comprising the steps of:
(A) co-extrusion of a hydrophilic external liquid phase and a lipophilic internal liquid phase, the external liquid phase comprising from 4 to 95% by weight of a hydrocolloid relative to the total dry weight of the shell, the internal liquid phase comprising 5 to 70% by weight of flavoring agents relative to the total weight of the core;
(B) solidification and/or gelation of the surface of the capsule obtained in step (A), by immersion in a fluid that is at a temperature of between 1° C. and 25° C.;
(C) drying of the capsule obtained in step (B);
(D) film coating of the capsule obtained in step (C) by an air spray coating process using a film coating solution comprising polyvinylidene chloride and water;
(E) retrieval of the capsule obtained in step (D).

22. Method according to claim 21, wherein the film coating solution further comprises a plasticizer chosen from triethyl citrate, polyhydric alcohols such as glycerol, sorbitol, and maltitol, polyvinyl alcohol, mono-, di-, and oligosaccharides, triacetin, polyethylene glycol, or a mixture thereof.

23. Use of a capsule according to claim 1, as an agent for the immediate and lasting release of a flavoring, said capsule being placed in a product contained in an oral-use pouch or in a consumable product comprising a filter and tobacco, in particular intended for use in a tobacco heating device.

24. Use according to claim 23, wherein, when the capsule is broken within the oral-use pouch or the consumable product, it emits an audible pop and releases the flavoring.
